(19) United States
(12) Patent Application Publication
(10) Pub. No.: US 2002/0008835 A1
(43) Pub. Date: Jan. 24, 2002

(54) LIQUID CRYSTAL DISPLAY DEVICE

(76) Inventor: SHIN TAHATA, HYOGO (JP)

Correspondence Address: MCDERMOTT WILL & EMERY, 600 13TH STREET, N.W., WASHINGTON, DC, 20005-3096, US

(21) Appl. No.: 09/228,273

(22) Filed: Jan. 11, 1999

(30) Foreign Application Priority Data
Jan. 13, 1998 (JP) 10-004604

(51) Int. Cl. G02F 1/1343

(52) U.S. Cl. 349/155

(57) ABSTRACT

A high quality in-plane switching type liquid crystal display device having high contrast ratio and free from any impression of irregular display surface is provided. Spacers which have small surface energy and no influence on orientation of liquid crystal molecules, for example those formed of divinyl benzene coated with a fluorine-coated resin are used, to suppress light passage through and around the spacers in the black (dark) display state. As a result, transmittance in the black (dark) state when the voltage is not applied is reduced to about 0.3% (contrast ratio of about 300) with the maximum transmittance when the voltage is applied being 100%. Irregularity of the display screen caused by the light passage around the spacers is not recognized and excellent display can be obtained.

### BACKGROUND OF THE INVENTION

1. Field of the Invention

The present invention relates to an in-plane switching type liquid crystal display device and, more specifically, to material of spacers used for keeping a space between panels.

2. Description of the Background Art

A liquid crystal display device which advantageously has the feature of thin form, light weight, low power consumption and so on has been widely used as a display device for a watch, a pocket calculator and the like. Especially, a TN (twisted nematic) type liquid crystal display device of which active driving is implemented by a thin film transistor (TFT) or the like has been increasingly popular in the field of display devices for word processors, personal computer and the like for which CRT (cathode lay tube) has been conventionally used. The TN type liquid crystal display device, however, generally has a narrow angle of visibility, and when viewed obliquely, contrast decreases and gradation is inverted. As the size of liquid crystal devices has been increased recently, it is the case that the state of display differs at upper, lower, left and right ends of a display screen even viewed from one same view point. Therefore, larger angle of visibility has been desired. Degradation in display quality when viewed obliquely may be caused by anisotropy in the direction of rising of liquid crystal molecules by an electric field. It may be the case that when liquid crystal molecules rising in one direction are viewed from various directions, optical contribution changes, which results in change in the state of display dependent on the angle of visibility. This is a problem inherent to the TN type liquid crystal display device.

In order to solve this problem, an in-plane switching type liquid crystal display device has been proposed. The principle of operation of the in-plane switching type liquid crystal display device will be described in the following with reference to the figures. FIGS. 3A and 3B are schematic illustrations showing the principle of operation of a common in-plane switching type liquid crystal display device. Interdigital electrodes including a plurality of electrodes 1 are arranged parallel to each other. The interdigital electrodes 1 are formed on an electrode substrate 3. Between a counter substrate 4 and electrode substrate 3, liquid crystal molecules 2 are arranged with an orientation film (not shown) interposed. A pair of polarization plates (not shown) are arranged on outer surfaces of electrode substrate 3 and counter substrate 4. FIG. 3A schematically shows a state of orientation of liquid crystal molecules 2 when no voltage is applied, while FIG. 3B shows the state of orientation when a voltage is applied. When the voltage is not applied, liquid crystal molecules 2 are oriented approximately vertical to the sheet surface. At this time, when one of the polarization plates is arranged with the transmission axes thereof aligned with the direction of orientation of the liquid crystal molecules and the other polarization plate is arranged orthogonal thereto, the liquid crystal layer does not have any influence on linearly polarized light beam entering from one polarization plate, and the light beam cannot pass through the other polarization plate. Therefore, the liquid crystal display device is in a black (dark) display state. When a voltage is applied between interdigital electrodes 1, an electric field is generated approximately parallel to the surface of the substrate, whereby direction of orientation of liquid crystal molecules changes. More specifically, birefringence of the liquid crystal layer changes, so that the incident light beam entering one polarization plate passes through the other polarization plate, and liquid crystal display device is in a white (bright) display state.

In the in-plane switching type liquid crystal display device, the liquid crystal molecules 2 switch approximately parallel to the substrate surface dependent on application/non-application of the voltage. Therefore, even when the viewing direction changes, optical contribution of liquid crystal molecules hardly changes. Therefore, even when viewing angle changes, the contrast ratio and display quality are not degraded. Thus, the device provides excellent viewing angle characteristics. Therefore, when the in-plane switching type liquid crystal display device is used in place of a CRT, the state of display hardly changes regardless of the viewing positions, and therefore a number of viewers can have high quality image display at one time. Therefore, such an application has been attracting attention as a promising liquid crystal display mode of the next generation.

As described above, in the in-plane switching type liquid crystal display device, optical axis of the liquid crystal layer is aligned with or orthogonal to the linearly polarized light beam entering the liquid crystal layer, and as the liquid crystal layer does not have birefringence, a black (dark) display state is attained. Therefore, brightness in the black (dark) state can be made lower than in other liquid crystal display mode represented by TN type display, for example. Accordingly, contrast ratio can be improved. In an actual in-plane switching type liquid crystal display device, however, uniaxial orientation disorder occurs near spacers used for keeping a space between panels, causing birefringence with respect to the incident light beam, resulting in elliptic polarization. This allows passage of light beam through the other polarization plate, which passage of light beam is viewed as whitening in the black (dark) state. The problem of light passage derived from the spacers themselves or from the disorder in liquid crystal orientation around the spacers as well as the problem that the viewer has an impression that display screen is irregular because of this light passage are significant particularly in those liquid crystal display devices which utilize the in-plane switching type liquid crystal display mode. More specifically, in a TN mode liquid crystal display device, which is the most popular mode of liquid crystal display at present, the light passage is not recognized as irregularity of the display screen and display quality is not degraded from the following reasons.

Disorder in orientation occurs around the spacers even in the TN mode liquid crystal display device. However, in the TN mode, white display is given when there is no voltage is applied and black display is given when the voltage is applied, generally. Though light passage is generated because of disorder in liquid crystal orientation around the spacers when the voltage is not applied, at that time, the display around such light passage is also in white. Therefore, the light passage cannot be recognized, and the display quality is not influenced at all. When a voltage is applied and black display is given, the electric field is also applied to the portion of disorder in liquid crystal orientation around the spacers. Therefore, the liquid crystal molecules are forced to be oriented in the direction of the electric field. Accordingly, when the black display is given, the region of disorder of liquid crystal orientation around the spacer can be made sufficiently small, and hence light passage is not recognized, and the display quality is not influenced.

Therefore, the problem of irregular display and degraded display quality caused by light passage around the spacers is particular to the in-plane switching type liquid crystal display mode, in which black display is given when the voltage is not applied.

The light passage, which is the problem particular to the in-plane switching type liquid crystal display device, will be described in detail with reference to FIGS. 4A and 4B.

In the figure, incident light beams are represented by arrows 5, and transmitted light beams 6 are represented by arrows 6. Polarization plates 7 and 8 are arranged with their transmission axes arranged orthogonal to each other. A spacer 9 is used in a conventional in-plane switching type liquid crystal display device. An arrow on polarization plate 7 represents that the transmission axis of polarization plate 7 is parallel to the surface of the sheet, while a circle on polarization plate 8 represents that the transmission axis of polarization plate 8 is vertical to the sheet surface. In the figures, portions corresponding to those of FIGS. 3A and 3B are denoted by the same reference characters and description thereof is not repeated.

Orientation of liquid crystal molecules 2 is as shown in FIG. 4A or 4B around conventional spacer 9 formed of an acrylate resin, a divinyl benzene resin or the like. Difference in the states of orientation is generally considered as dependent on affinity between liquid crystal molecules 2 and spacer 9. When the affinity is high, liquid crystal molecules 2 are oriented with their longer axes aligned in a tangential direction of spacer 9 as shown in FIG. 4A, and if the affinity is low, liquid crystal molecules 2 are oriented with their longer axes aligned with normal direction of the spacer as shown in FIG. 4B. At this time, at a portion where liquid crystal orientation is in disorder, light beam 5 entering from the lower side of the panel is transmitted to the upper side of the panel because of the influence of birefringence of the liquid crystal layer, and viewed as a light passage at and around spacer 9. This light passage is particularly noticed when the display is in black (dark) state. As brightness (transmittance) in the black (dark) state increases, contrast ratio, which is one of the display characteristics of the liquid crystal display device, that is, (brightness (transmittance) in the white (bright) state)/(brightness(transmittance) in the black (dark) state) degrades. Further, by this light passage, the viewer has an impression that the display screen is irregular.

### SUMMARY OF THE INVENTION

The present invention was made to solve the above described problems, and its object is to provide a liquid crystal display device having high display quality with high contrast ratio and free of any impression of irregular display surface.

The present invention provides an in-plane switching type liquid crystal display device including an electrode substrate having a plurality of electrodes arranged parallel to each other, a counter substrate sandwiching, together with the electrode substrate, liquid crystal with an orientation film interposed, a pair of polarization plates arranged on outer surfaces of the electrode substrate and the counter substrate with respective transmission axes orthogonally crossing with each other, and spacers for keeping constant a space between the electrode substrate and the counter substrate in which a voltage is applied between the plurality of electrodes to generate an electric field approximately parallel to the substrate surface, causing switch of the liquid crystal molecules approximately parallel to the substrate surface, and birefringence of the liquid crystal layer changes, whereby a white (bright) display is given when an incident light beam which has passed through one of the polarization plates is transmitted through the other transmission plate and a black (dark) display is given when the incident light beam which has passed through one of the transmission plates is not transmitted through the other polarization plate, characterized in that spacers having no influence on orientation of liquid crystal molecules are used to suppressed light passage through and around spacers in the black (dark) display, so that brightness in the black (dark) display state is suppressed to be at most 1% of the brightness in the white (bright) display state.

Preferably, the spacers are formed of a material of which surface energy is low enough not to influence orientation of the liquid crystal molecules.

Further, the spacers each preferably have at least a surface formed of fluorine-contained resin.

Further, the present invention provides an in-plane switching type liquid crystal display device including an electrode substrate having a plurality of electrodes arranged parallel to each other, a counter substrate sandwiching, together with the electrode substrate, liquid crystal with an orientation film interposed, a pair of polarization plates arranged on outer surfaces of the electrode substrate and the counter substrate with respective transmission axes orthogonally crossing with each other, and spacers for keeping constant a space between the electrode substrate and the counter substrate, in which a voltage is applied between the plurality of electrodes to generate an electric field approximately parallel to the substrate surface, causing switch of the liquid crystal molecules approximately parallel to the substrate surface, and birefringence of the liquid crystal layer changes, whereby a white (bright) display is given when an incident light beam which has passed through one of the polarization plates in transmitted through the other polarization plate and a black (dark) display is given when the incident light beam which has passed through one polarization plate is not transmitted through the other polarization plate, characterized in that transmittance of visible light of the spacer is set to be at most about 50%.

Further, preferably the spacer contains a dye.

As described above, according to the present invention, spacers which do not have any influence on the orientation of liquid crystal molecules are used, so as to suppress light passage through and around the spacers in the black (dark) display state, whereby the brightness of the black (dark) display state is suppressed to be at most 1% of the brightness in the white (bright) display state. Therefore, a high quality in-plane switching type liquid crystal display device having high contrast ratio and free from any impression of irregular display surface can be obtained.

Further, spacers containing a dye are used to attain transmittance of visible light of the spacers of at most 50%. Therefore, light passage generated at the spacer portions in the black (dark) display state can be suppressed and a high quality in-plane switching type liquid crystal display device having high contrast ratio and free from any impression of irregular display surface can be obtained.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross sectional view of an in-plane switching type liquid crystal display device in accordance with a first embodiment of the present invention.

FIG. 2 is a cross sectional view of an in-plane switching type liquid crystal display device in accordance with a fourth embodiment of the present invention.

FIGS. 3A and 3B are illustrations of the principle of operation of a common in-plane switching type liquid crystal display device.

FIGS. 4A and 4B are illustrations related to light passage caused by spacers in the conventional in-plane switching type liquid crystal display device.

### DESCRIPTION OF THE PREFERRED EMBODIMENTS

First Embodiment

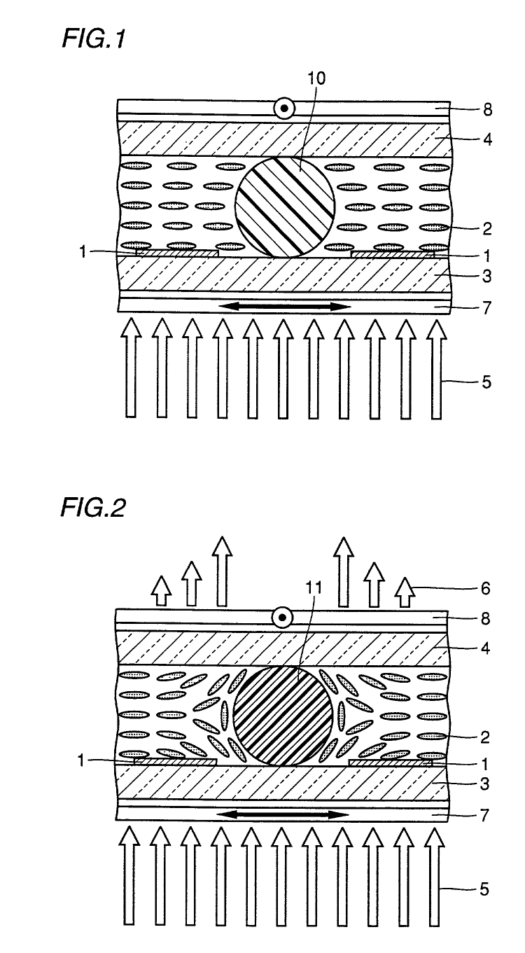

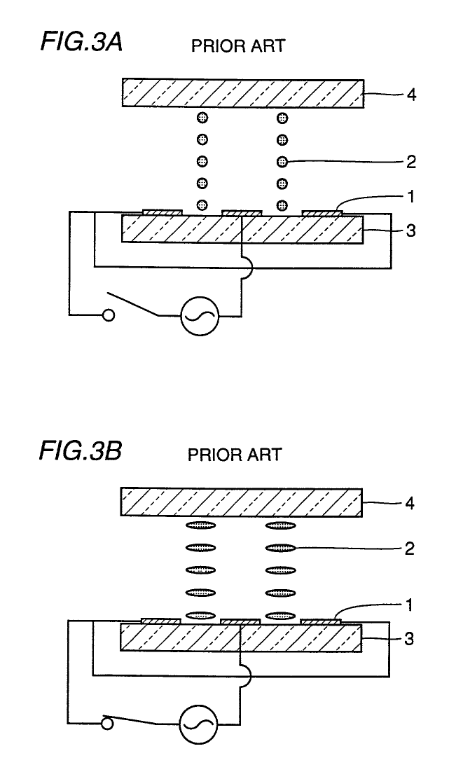

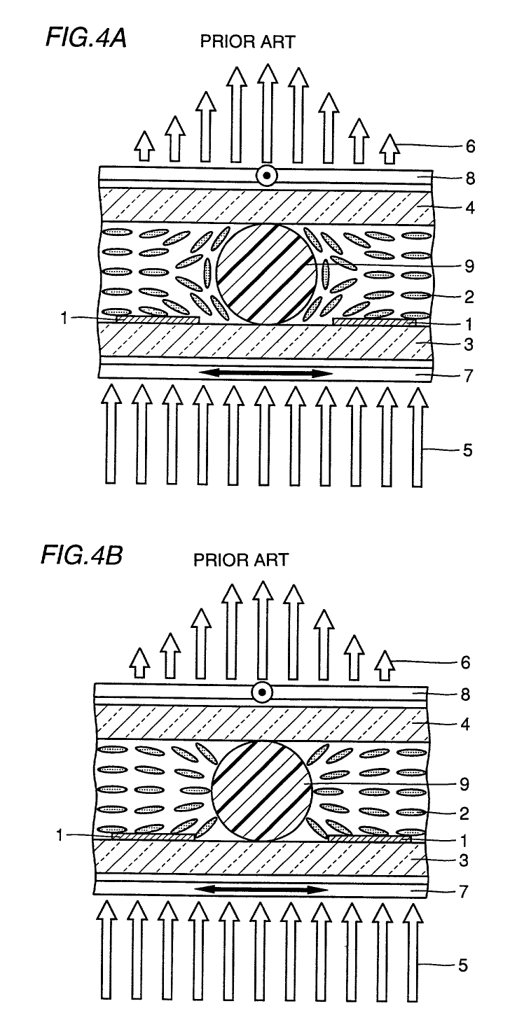

In the following, embodiments of the present invention will be described. As can be seen from FIG. 1, interdigital electrodes 1 include a plurality of electrodes arranged parallel to each other. On an electrode substrate 3, the plurality of interdigital electrodes 1 are arranged. Between electrode substrate 3 and counter substrate 4, liquid crystal molecules 2 are held with an orientation film (not shown) interposed. A pair of polarization plates 7 and 8 are arranged with respective transmission axes arranged orthogonal to each other, on outer surfaces of electrode substrate 3 and counter substrate 4. Spacers 10 are provided for keeping constant a space between electrode substrate 3 and counter substrate 4, which spacers are, in the present embodiment, formed by using a divinyl benzene resin as a raw material with the surface coated by a fluorine-contained resin. The arrow on polarization plate 7 represents that the transmission axis of polarization plate 7 is parallel to the surface of the sheet, and the circle on polarization plate 8 represents that the transmission axis of polarization plate 8 is vertical to the surface of the sheet.

In the in-plane switching type liquid crystal display device in accordance with the present embodiment, a voltage is applied between the plurality of interdigital electrodes 1 provided on electrode substrate 3 to generate an electric field approximately parallel to the surface of the substrate, whereby liquid crystal molecules 2 switch approximately parallel to the substrate surface to change birefringence of the liquid crystal molecules 2. Accordingly, when incident light beams 5 passed through one polarization plate 7 are transmitted through the other polarization plate 8, a white (bright) display state is attained, and when incident light beams passed through one polarization plate 7 are not transmitted through the other polarization plate 8, a black (dark) display state is given. As spacers 10, those having no influence on the orientation of liquid crystal molecules 2 are used to suppress light passage generated through and near the spacers 10 in the black (dark) display state, whereby the brightness in the black (dark) display state is suppressed to be at most 1% of the brightness in the white (bright) display state.

The method of manufacturing a liquid crystal display device in accordance with the present embodiment will be described. First, chromium film is grown to the thickness of 1000 Å on a glass substrate, and a plurality of interdigital electrodes 1 are formed by common patterning, whereby electrode substrate 3 is fabricated. The width of each of interdigital electrode 1 is set to 5 μm, and an interval between the electrodes is set to be 10 μm. Thereafter, an orientation film solution (manufactured by NIPPON GOSEI GOM, AL1044) is applied by transfer method to electrode substrate 3 and counter substrate 4, and cured at 180° C. for 1 hours, thereby forming an orientation film. The orientation film on electrode substrate 3 is subjected to rubbing process in a direction at an angle of 10° with respect to the direction of interdigital electrodes 1. The direction of rubbing of counter electrode 4 is set to be anti-parallel to the rubbing direction of electrode substrate 3. Thereafter, a seal material is applied to electrode substrate 3, spacers 10 each having the diameter of 3.5 μm are distributed to counter electrode 4 at the density of 400 particles/mm², and thereafter electrode substrate 3 and counter substrate 4 are superposed with directions of orientation processing anti-parallel to each other, and subjected to thermal compression bonding, whereby a panel is provided. Thereafter, a liquid crystal composition having anisotropy of dielectric constant of Δ∈=+10, anisotropy of refractive index of Δn=0.083 and specific resistance of at least 10¹² Ωcm is filled and sealed, and thus an in-plane switching type liquid crystal display device is completed.

The spacers 10 of which surface is coated with a fluorine-contained resin has smaller surface energy as compared with those at which surface divinyl benzene, which is the raw material of spacers 10 is exposed, and therefore the spacers have less influence on birefringence or orientation of liquid crystal molecules 2. Therefore, incident light beams 5 from the lower side of the panel cannot be transmitted through the upper polarization plate 8, and hence there is no light passage. Accordingly, it is possible to lower brightness in the black (dark) display state.

In the in-plane switching type liquid crystal display device manufactured in accordance with the present embodiment, the transmittance in the black (dark) state when the voltage is not applied is about 0.3% (contrast ratio of about 300), with the maximum transmittance when the voltage is applied being represented as 100%. Irregularity of the display derived from light passage around spacers 10 was not visually recognized, and excellent display could be obtained.

Second Embodiment

In the second embodiment of the present invention, spacers prepared by using an acrylate resin as a raw material and having surfaces coated with a fluorine-contained resin are used as spacer material for preventing light passage. Other material and the method of manufacturing the in-plane switching type liquid crystal display device of the present embodiment are similar to those of the first embodiment described above. Therefore, description is not repeated.

The spacers in accordance with the present embodiment have the surface coated with a fluorine-contained resin, and therefore the spacers have smaller surface energy as compared with those having an acrylate resin as the raw of the spacers exposed, and therefore the spacers do not have influence on the orientation or birefringence of the liquid crystal molecules. Therefore, incident light beams from the lower side of the panel cannot pass through the upper polarization plate, and hence light passage does not occur. Accordingly, it is possible to lower brightness in the black (dark) display state.

In the in-plane switching type liquid crystal display device manufactured in accordance with the present embodiment, transmittance in the black (dark) state when the voltage was not applied was about 0.4% (contrast ratio of about 250), with the maximum transmittance when the voltage was applied being 100%. Irregularity of the display surface caused by light passage around the spacers was not visually recognized, and excellent display could be obtained.

As comparative examples to the embodiments 1 and 2, in-plane switching type liquid crystal display devices were manufactured using spacers formed of an acrylate resin (Comparative Example 1) and divinyl benzene resin (Comparative Example 2), which have been widely used in the prior art. Other materials and manufacturing methods were the same as those of the first embodiment. In the in-plane switching type liquid crystal display device of Comparative Example 1, transmittance in the black (dark) state when the voltage was not applied was about 1.5% (contrast ratio of about 67), with the maximum transmittance when the voltage was applied being 100%. In the in-plane switching type liquid crystal display device of Comparative Example 2, the transmittance in the black (dark) state was about 2% (contrast ratio of about 50). Both in Comparative Examples 1 and 2, there was considerable light passage around the spacers, and irregularity of the display screen caused by the light passage was visually recognized. Display quality of these comparative examples was poor.

Third Embodiment

In the third embodiment, spacers formed of a fluorine-contained resin is used as spacer material for providing light passage. Other material and manufacturing method for the in-plane switching type liquid crystal display device in accordance with the present embodiment are similar to those of the first embodiment. Therefore, description thereof is not repeated.

The spacers formed of fluorine-contained resin in accordance with the present embodiment has smaller surface energy as compared with the conventional spacers formed of an acrylate resin and a divinyl benzene resin, and therefore the spacers do not have influence on the orientation or birefringence of the liquid crystal molecules. Therefore, incident light beams from the lower side of the panel cannot pass through the upper polarization plate, and therefore light passage is not generated. Accordingly, it is possible to lower brightness in the black (dark) display state.

In the in-plane switching type liquid crystal display device manufactured in accordance with the present embodiment, transmittance in the black (dark) state when the voltage was not applied was about 0.25% (contrast ratio of about 400) with the maximum transmittance when the voltage was applied being 100%, irregularity of the display surface caused by the light passage around the spacers was not visually recognized, and excellent display could be obtained.

Though spacers formed entirely of a fluorine-contained resin are used in the present embodiment, similar effects can be expected provided that at least the surface of the spacers is formed of a fluorine-contained resin.

Fourth Embodiment

Referring to FIG. 2, spacers 11 are formed of a divinyl benzene resin impregnated with a dye, so that the spacers come to have transmittance of visible light of 40%. In the figures, portions corresponding to those of FIG. 1 are denoted by the same reference characters and description thereof is not repeated.

The in-plane switching type liquid crystal display device in accordance with the present embodiment was manufactured by superposing the electrode substrate and the counter substrate fabricated using the same material and through the same method as in the first embodiment to provide a panel, to which a liquid crystal composition having anisotropy of dielectric constant of Δ∈=+7.5, anisotropy of refractive index of Δn=0.079 and specific resistance of at least 10¹² Ωcm was introduced and sealed.

Around the spacers 11 containing a dye in accordance with the present embodiment, there is disorder in orientation similar to the conventional spacers formed solely of divinyl benzene resin, as shown in FIG. 2, resulting in light passage. However, light passage through the spacers 11 can be reduced. Therefore, in the device as a whole, the brightness in the black (dark) display state can be made lower than the prior art. In the present embodiment, transmittance of spacers 11 is set to 40%. The transmittance should preferably be about 50% or lower.

In the in-plane switching type liquid crystal display device manufactured in the present embodiment, transmittance in the black (dark) state when the voltage was not applied was about 0.8% (contrast ratio of about 125) with the maximum transmittance when the voltage was applied being 100%. Irregularity of the display screen derived from light passage around spacers was not visually recognized, and excellent display could be obtained.

Structures and effects of the first to fourth embodiments of the present invention as well as Comparative Examples 1 and 2 are as shown in Table 1.

TABLE 1

| | | Liquid | | Surface |
|---|---|---|---|---|
| | Spacers | Crystal | Contrast | Irregularity |
| 1st | Divinyl benzene | Δε = +10 | 300 | ∘ |
| Embodiment | resin/fluorine- | Δn = 0.082 | | |
| | contained resin | | | |
| 2nd | Acrylate resin/ | Δε = +10 | 250 | ∘ |
| Embodiment | fluorine-contained | Δn = 0.082 | | |
| | resin | | | |
| 3rd | Fluorine- | Δε = +10 | 400 | ∘ |
| Embodiment | contained resin | Δn = 0.082 | | |
| 4th | Divinyl benzene | Δε = +7.5 | 125 | ∘ |
| Embodiment | resin/dye | Δn = 0.079 | | |
| Comparative | Acrylate resin | Δε = +10 | 67 | x |
| Example 1 | | Δn = 0.082 | | |
| Comparative | Divinyl benzene | Δε = +10 | 50 | x |
| Example 2 | resin | Δn = 0.082 | | |

The types of liquid crystal materials which can be used in the first to fourth embodiments described above are not specifically limited. Any liquid crystal material used in the common TN type liquid crystal display device may be used. The value Δ∈ of anisotropy of dielectric constant of the liquid crystal material is not specifically limited. However, desirable range is 1 to 12. When the value Δ∈ of the anisotropy of dielectric constant of the liquid crystal material is smaller than 1, response to the electric field is too weak, so that high voltage is necessary for driving. Further, if the value exceeds 12, the liquid crystal material is much polarized, and therefore it tends to include impurity such as ionic impurity, possibly resulting in degradation of the liquid crystal material. The product value of Δn of anisotropy of refractive index of the liquid crystal material by panel gap is not specifically limited. However, the desired value is 0.1 μm to 0.4 μm. Even if the value is smaller than 0.1 μm or larger than 0.4 μm, display is possible. However, there is much coloring, making it difficult to ensure satisfactory color reproductivity.

The types of liquid crystal orientation film which may be used in the first to fourth embodiments described above are not specifically limited. Soluble polyimid, amic acid firing type polyimid or the like used for a common liquid crystal display device may be used. Though magnitude of pretilt angle is not specifically limited, it should be at most 10°. If the angle exceeds 10°, angle dependency of the angle of visibility is too large, making it difficult to ensure superior characteristic of angle of visibility of the in-plane switching type liquid crystal display device. In the first to fourth embodiments described above, common substrate material such as glass, quartz or the like used in the conventional liquid crystal display device may be used. Further, a metal film of Al, Cr or the like, a metal oxide film or a multi-layered film including these films may be used as the material of interdigital electrode of the present invention.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A liquid crystal display device, comprising:
an electrode substrate having a plurality of electrodes arranged parallel to each other;
a counter substrate, together with said electrode substrate, sandwiching a liquid crystal layer including liquid crystal molecules, with an orientation film interposed;
a pair of polarization plates formed on the outer surfaces of said electrode substrate and said counter substrate, respectively, with respective transmission axes arranged orthogonal to each other; and
a plurality of spacers arranged between said electrode substrate and said counter substrate to keep constant a space therebetween; wherein
by applying a voltage between said plurality of electrodes to generate an electric field approximately parallel to a surface of said electrode substrate and to cause switch of said liquid crystal molecules approximately parallel to the surface of said electrode substrate, birefringence of said liquid crystal layer is changed, so that a white (bright) display state is given when an incident light beam passed through one of said polarization plates is transmitted through the other of said polarization plates and a black (dark) display state is given when the incident light beam passed through one of said polarization plates is not transmitted through the other of said polarization plates;
said liquid crystal display device further comprising
means for suppressing brightness in the black (dark) display state to be at most 1% of brightness in the white (bright) display state.

2. The liquid crystal display device according to claim 1, wherein said spacers are formed of a material of which surface energy is small enough not to have any influence on orientation of said liquid crystal molecules.

3. The liquid crystal display device according to claim 2, wherein said spacers have at least a surface formed of a fluorine-contained resin.

4. The liquid crystal display device according to claim 3, wherein said spacers are formed of a divinyl benzene resin with its surface coated with a fluorine-contained resin.

5. The liquid crystal display device according to claim 3, wherein said spacers are formed of an acrylate resin with its surface coated with a fluorine-contained resin.

6. The liquid crystal display device according to claim 3, wherein said spacers are formed of a fluorine-contained resin.

7. A liquid crystal display device, comprising:
an electrode substrate having a plurality of electrodes arranged parallel to each other;
a counter substrate, together with said electrode substrate, sandwiching a liquid crystal layer including liquid crystal molecules, with an orientation film interposed;
a pair of polarization plates formed on outer surfaces of said electrode substrate and said counter substrate, respectively, with respective transmission axes arranged orthogonal to each other; and
a plurality of spacers arranged between said electrode substrate and said counter substrate to keep constant a space therebetween,
said spacers having at least a surface formed of a fluorine-contained resin.

8. The liquid crystal display device according to claim 7, wherein said spacers each have a body portion formed of a synthetic resin and having a surface, and a surface portion formed of a fluorine-contained resin coating the surface of said body portion.

9. A liquid crystal display device, comprising:
an electrode substrate having a plurality of electrodes arranged parallel to each other;
a counter substrate, together with said electrode substrate, sandwiching a liquid crystal layer including liquid crystal molecules, with an orientation film interposed;
a pair of polarization plates formed on outer surfaces of said electrode substrate and said counter substrate, respectively, with respective transmission axes arranged orthogonal to each other; and
a plurality of spacers arranged between said electrode substrate and said counter substrate to keep constant a space therebetween; wherein
by applying a voltage between said plurality of electrodes to generate an electric field approximately parallel to a surface of said electrode substrate and to cause switch of said liquid crystal molecules approximately parallel to the surface of said electrode substrate, birefringence of said liquid crystal layer is changed, so that a white (bright) display state is given when an incident light beam passed through one of said polarization plates is transmitted through the other of said polarization plates and a black (dark) display state is given when the incident light beam passed through one of said polarization plates is not transmitted through the other one of said polarization plates; and
transmittance of said spacer with respect to visible light is at most 50%.

10. The liquid crystal display device according to claim 9, wherein said spacers contain a dye.

11. The liquid crystal display device according to claim 10, wherein said spacers are formed of a synthetic resin impregnated with a dye.

12. The liquid crystal display device according to claim 11, wherein said spacers are formed of a divinyl benzene resin impregnated with a dye.
